(19) United States
(12) Patent Application Publication
(10) Pub. No.: US 2024/0193517 A1
(43) Pub. Date: Jun. 13, 2024

(54) VIRTUAL INTELLIGENT COMPOSITE PERSONA IN THE METAVERSE

(71) Applicant: International Business Machines Corporation, Armonk, NY (US)

(72) Inventors: Robert Paul Lukasik, New York, NY (US); Christopher F. Ackermann, Fairfax, VA (US); Jeremy R. Fox, Georgetown, TX (US); Jennifer M. Hatfield, San Francisco, CA (US)

(21) Appl. No.: 18/062,747

(22) Filed: Dec. 7, 2022

(51) Int. Cl. G06Q 10/06; G06F 40/20; G06K 9/62

(52) U.S. Cl. CPC G06Q 10/0633; G06F 40/20; G06K 9/6267

(57) ABSTRACT

A system implements a method that comprises receiving end user information of end users to produce synthesized user research data, storing the synthesized user research data in a knowledge corpus, and segmenting the end users into one or more end user segments based on end user roles or end user categories. For each end user segment, a persona is generated, each representing a composite of end users in a respective end user segment. The method further comprises training each persona with training data from the synthesized user research data of the end users in the respective end user segment, and generating a dialog engine for each persona based on the training. An avatar is connected to each persona, and each avatar is made accessible for dialog with metaverse users in the Metaverse, which is a 3D virtual reality environment.

### BACKGROUND

During critical parts of design thinking workshops, or other human-centered design processes, it is not easy or feasible to gather needed insights in real-time that aid in decision-making. Moving forward without refining or appending initial research learnings, validating ideas, or addressing assumptions can result significant productivity losses. The Metaverse provides a new form of interaction between users and the computer that implements a user interface full of information and feedback.

### SUMMARY

Disclosed herein is a method for Metaverse collaboration. The method comprises receiving end user information of end users to produce synthesized user research data, storing the synthesized user research data in a knowledge corpus, and segmenting the end users into one or more end user segments based on end user roles or end user categories. For each end user segment, a persona is generated, each representing a composite of end users in a respective end user segment. The method further comprises training each persona with training data from the synthesized user research data of the end users in the respective end user segment, and generating a dialog engine for each persona based on the training. An avatar is connected to each persona, and each avatar is made accessible for dialog with metaverse users in the Metaverse, which is a 3D virtual reality environment.

Also disclosed herein is a Metaverse collaboration apparatus, comprising a memory, and a processor. The processor is configured to receive end user information of end users to produce synthesized user research data, store the synthesized user research data in a knowledge corpus, and segment the end users into one or more end user segments based on end user roles or end user categories. The processor is further configured to generate, for each end user segment, a persona, each representing a composite of end users in a respective end user segment. The processor is further configured to train each persona with training data from the synthesized user research data of the end users in the respective end user segment, and generate a dialog engine for each persona based on the training. The processor connects an avatar to each persona, and makes each avatar accessible for dialog with metaverse users in the Metaverse.

Further disclosed herein is a computer program product for a Metaverse collaboration apparatus, the computer program product comprising one or more computer readable storage media, and program instructions collectively stored on the one or more computer readable storage media. The program instructions comprise program instructions to receive end user information of end users to produce synthesized user research data, store the synthesized user research data in a knowledge corpus, and segment the end users into one or more end user segments based on end user roles or end user categories. The program instructions are further configured to, when executed on the processor, generate, for each end user segment, a persona, each representing a composite of end users in a respective end user segment, train each persona with training data from the synthesized user research data of the end users in the respective end user segment, and generate a dialog engine for each persona based on the training. The instructions further allow the processor to connect an avatar to each persona, make each avatar accessible for dialog with metaverse users in the Metaverse, receive persona interaction data based on an interacting persona that interacts with a metaverse user, and add the persona interaction data to the training data in the knowledge corpus. The instructions further allow the processor to subsequently train an other persona using the persona interaction data in the training data of the knowledge corpus, add end user questions and end user responses to the synthesized user research data in the knowledge corpus, create a question and answer component as a part of the dialog engine that is usable by an interacting persona, and apply generated insights during situational analysis while EDT activities are in progress. The knowledge corpus comprises persona data, environment data, and workflow data, and the end user information comprises end user answers from end users in response to end user questions. Each avatar is accessible within a metaverse environment. The metaverse environment is a virtual enterprise design thinking workshop (VEDTW), the metaverse users are VEDTW students, the dialog engine is structured around the VEDTW, and the dialog engine facilitates questions, comments, conversations, and random injections. The producing of the synthesized user research data comprises using machine learning and natural language processing to update the knowledge corpus, identifying common patterns and themes, and using the common patterns and themes in the generating of the persona.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a general computing device and environment.

FIG. 2 is a block diagram illustrating various elements associated with creating and using a virtual intelligent composite persona in the metaverse, according to various embodiments.

FIG. 3 is a flowchart that illustrates a process associated with creating and using a virtual intelligent composite persona in the metaverse, according to various embodiments.

### DETAILED DESCRIPTION

The following general acronyms may be used below:

TABLE 1
General Acronyms

| | |
|---|---|
| CD-ROM | compact disc ROM |
| CPP | computer program product |
| DVD | digital versatile disk |
| EPROM | erasable programmable read-only memory |
| EUD | end-user device |
| IoT | Internet of Things |
| LAN | local-area network |
| NFC | near field communication |
| RAM | random access memory |
| ROM | read-only memory |
| SAN | storage area network |
| SD | secure digital |
| SDN | software-defined networking |
| SRAM | static random-access memory |
| UI | user interface |
| USB | universal serial bus |
| VCE | virtual computing environment |
| WAN | wide-area network |

### Data Processing System in General

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

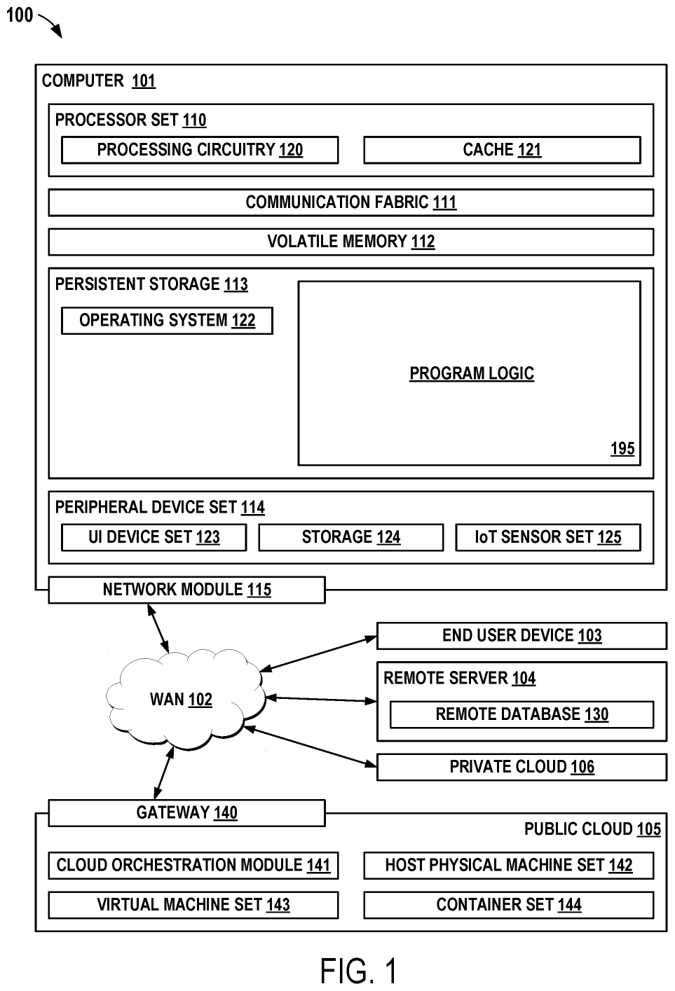

FIG. 1 is a block diagram of a general computing device and environment. Computing environment 100 contains an example of an environment for the execution of at least some of the computer code involved in performing the inventive methods, such as the program logic 195. In addition to the program logic 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program logic 195, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the program logic 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the program logic 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention are presented for purposes of illustration, but are not intended to be exhaustive or limited to the embodiments disclosed. Many modifications and variations will be apparent to those of ordinary skill in the art without departing from the scope and spirit of the described embodiments. The terminology used herein has been chosen to best explain the principles of the embodiments, the practical application or technical improvement over technologies found in the marketplace, or to enable others of ordinary skill in the art to understand the embodiments disclosed herein. In the description below, reference numbers in the FIGs. may include an extension, e.g., “xxx.1”. Use of these reference numbers without the extension may refer to elements collectively or representatively, depending on the context.

### Virtual Intelligent Composite Persona in the Metaverse

The following application-specific acronyms may be used below:

TABLE 2
Application-Specific Acronym

| | |
|---|---|
| EDT | enterprise design thinking |
| ML | machine learning |
| NLP | natural language processing |
| UCD | User Centered Design |
| VEDTW | virtual design thinking workshop |
| VR | virtual reality |
| XR | extended reality |

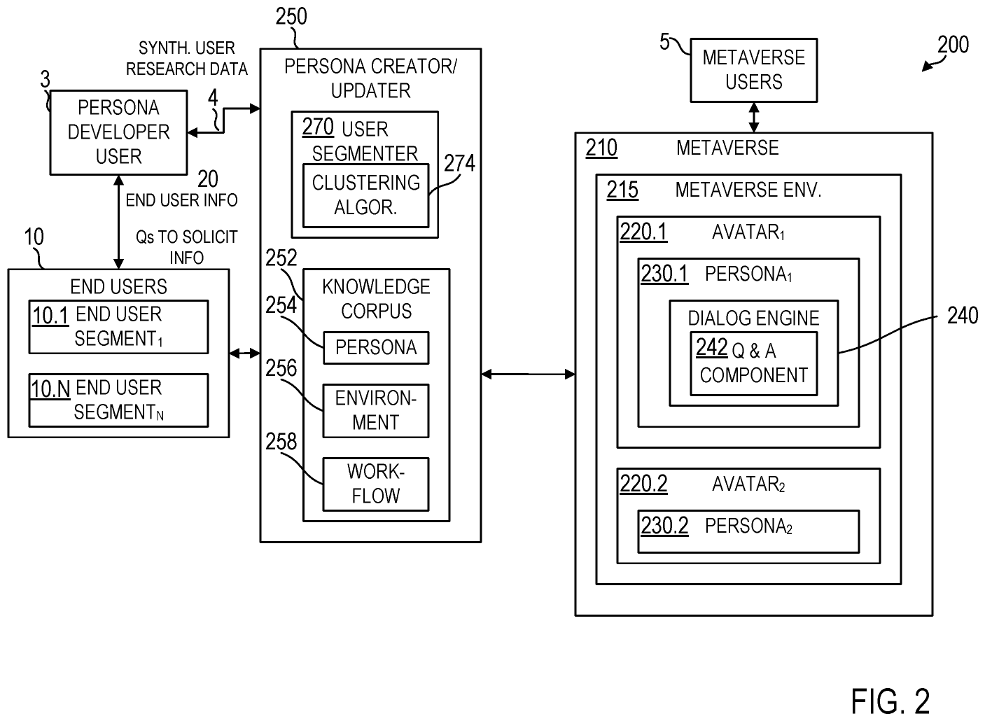

FIG. 2 is a block diagram of an embodiment of an environment 200 in which real-world users, such as persona developer users 3, metaverse users 5, and end users 10, may create and interact with a persona 230 within the Metaverse 210 or a constituent metaverse environment 215.

The Metaverse 210 is a hypothetical iteration of the Internet as a single, universal, and immersive virtual world that is facilitated by the use of virtual reality (VR) and augmented reality (AR) headsets. In colloquial use, a Metaverse 210 is a network of 3D virtual worlds focused on social connection. Avatars 220 are part of the Metaverse 210. Infusing an avatar 220 with pertinent metadata (its knowledge corpus in the form of a persona 230) builds a unique type of hypothetical “user” that can be represented by a generated avatar 220. This avatar 220 does not represent a real person within the Metaverse 210, but rather represents, e.g., an ability to have “data” drive a hypothetical avatar test case.

Understanding the actual end user 10 is important in user-centered design (UCD) engagements and product development. Various embodiments described herein provide a dynamic composite persona 230 representing a virtual end user (or multiple users) in a virtual environment (e.g., the metaverse environment 215) by generating an artificial virtual embodiment avatar 220 having a persona 230 within the Metaverse 210. This may provide another dimension to a UCD with an infusion into the Metaverse 210.

A virtual dynamic composite persona 230 is created within the Metaverse 210 that evaluates, tracks, and provides inputs during a collaborative exchange, workshop, or ongoing initiative. A dynamic virtual persona avatar presentation layer may be applied within various metaverse environments 215 based within the Metaverse 210. An avatar 220 representing or incorporating a persona type 230 may be designed for the VR environment that allows for various types of avatar 220 feedback. This would be an interactive experience in a conversational model, much like a digital assistant interface, but based as an avatar 220 within the Metaverse 210. The concept of having the persona 230.1 unique to that particular type of end user 10.1 can then appear within the Metaverse 210.

The synthesized user research data 4 may also be used to evaluate impact during, but not limited to, enterprise design thinking (EDT) workshops and developing intelligent workflows. EDT is a principled methodology that sees problems and solutions as an ongoing conversation, and focuses on user outcomes. It drives business by helping users achieve their goals. It utilizes reinvention and staying essential by treating everything as a prototype, and moves fast by empowering diverse teams to act. It utilizes a loop for understanding the present and envisioning the future in a continuous cycle of observing (immersing oneself in the real world), reflecting (coming together and looking within), and making (giving a concrete form to abstract ideas).

Intelligent workflows may be powered by a combination of data enabled on a hybrid multi-cloud infrastructure, exponential technologies, and employee expertise. By unlocking greater visibility, real-time insights and the power to remediate problems across multiple business functions, intelligent workflows may transform the nature of work to deliver exponential outcomes for a business. The transformative power of intelligent workflows may help: a) evolve siloed, static processes into integrated, transparent, end-to-end workflows; b) move from predictions based on outdated data to actions based on real-time insight; c) go beyond automation of standardized processes to orchestration and augmentation of variable tasks; and d) replace repetitive, mundane tasks with higher-value, knowledge-based work.

Questions and answers, plus insights (per EDT activity), may be the primary method of engagement between metaverse users 5, such as workshop participants, and the persona 230. Metaverse users 5 may be able to engage with the persona 230 like they would with another other normal metaverse user 5/workshop participant within the metaverse environment 215. In the EDT implementation, there could be multiple personas 230.1-230.N in a single EDT workshop with breakout groups assigned to a specific persona 230.1. The persona creator/updater 250 may review inputs to a persona 230, such as data and questions. The persona creator/updater 250 may review outputs from a persona 230, such as answers and insights within certain types of metaverse environments 215. Based on the type of metaverse environment 215, the persona creator/updater 250 can alter/adjust the responses to questions or other activities of the metaverse users 5 or environmental changes made by the virtual avatar 220. The persona creator/updater 250, and the metaverse environment 215 and various components described herein may be implemented as the program logic 195 and may be run in a computing environment 100 one or more computers 101, as described above.

The persona 230 provides real-time insight generation derived from research inputs, such as the synthesized user research data 4. This may be in the form of a rendered avatar 220 within the Metaverse 210 that may resemble (but is not limited to) a typical user's persona 230 of the application, asset, or process. The persona 230 may be a guiding force of intelligence within the Metaverse 210 to facilitate questions, comments, conversations, and random injections.

The generated insights may then be applied during situational analysis while EDT activities are in progress. For instance, an analysis of specific activity outputs may occur, mapping these outputs to research learnings—such as mapping AS IS scenarios to actual AS IS processes (per gathered research pre-EDT workshop) with the persona 230 generating additional insights, gaps, and opportunities within the Metaverse 210 within real time feedback from the avatar 220 to surrounding real human metaverse users 5.

The systems and methods described herein may imply any user's opt-in to the terms and conditions for usage and participation. Within the Metaverse 210, a metaverse user 5 may proceed through the virtual process flow described below for digital asset interactions and creation of persona 230 interactions.

In order to create and implement a composite extended reality (XR) persona(s) 230, various operations are performed. The persona 230 may be created based on the end-users 10 by the persona developer user 3. The persona 230 is implemented by an avatar 220 within a metaverse environment 215 of the Metaverse 210. The persona developer user 3 creates the persona 230 with the assistance of the persona creator/updater 250 based on ultimate end users 10 of metaverse users 5. The environment 200 described herein relates to an embodiment involving enterprise design thinking (EDT) workshops and the development of intelligent workflows, however the invention is not so limited and may extend to the implementation of any form of persona 230 within the Metaverse 210.

The Metaverse 210 contains a plurality of avatars 220, which each may embody a persona 230 (which may be construed as a “personality” of an avatar 220). The avatar 220 is an icon or figure representing a particular person or other 3D visual and audio representation of an entity that embodies the persona 230 in the Metaverse 210. The persona 230 is a personality that may access the Metaverse knowledge corpus 252 for interacting with others. In various embodiments described herein, the persona 230 includes a dialog engine 240, which contains a question-and-answer component 242 (these being described in more detail below).

The persona 230 may be created as a composite of multiple end users 10 or end user segments 10.X, as opposed to a single end user 10. There does not have to be a one-to-one correspondence of these aspects in the hierarchy, e.g., an avatar 220 can be associated with different selectable personas 230, while a certain persona 230 may be used by a plurality of avatars 220. In other words, there may be a many-to-many relationship between avatars 220 and the respective personas 230 that they embody. Each persona 230.1-230.N may have a corresponding dialog engine 240 associated with it. In the discussion below, after a persona 230 has been created and associated with an avatar 220, the two co-exist together, and hence reference may be made to an avatar 220 when actually the avatar 220—persona 230 pair is intended. Thus, where it is context appropriate, the avatar 220 and/or the persona 230 may refer to the avatar-persona pair for the sake of simplicity.

There are two primary times associated with this system: the first is a persona 230 creation time during which the persona 230 is created; and the second is a metaverse user 5 access time, during which the metaverse users 5 interact with the persona 230. A third time may also be defined, which is a persona 230 update time, during which feedback may be used to update the persona.

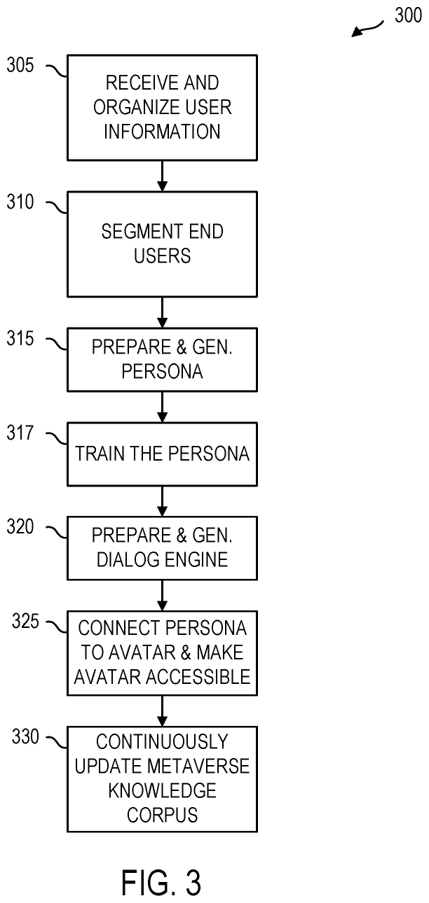

FIG. 3 is a process 300, according to some of the embodiments described herein. The process 300 discussed in FIG. 3 will be discussed in conjunction with the block diagram of FIG. 2. The process 300 may be broken down into several operations, including: receiving and organizing user information 305, end user segmentation 310, preparing and generating a persona 315, preparing and generating a dialog engine 320, connecting the persona to the avatar 325, and continuously updating the metaverse knowledge corpus for the avatar 330. These process operations are discussed in more detail below.

### Receiving and Organizing User Information 305: Understanding and Defining the User in the Metaverse

In an initial operation, receiving and organizing user information 305, synthesized research about end user(s) 10 from various data sources may be used to produce the synthesized user research data 4. First, one or more primary end users 10 may be identified by the persona developer user 3. Research may then be conducted on the primary end user(s) 10, and the results of the research may be provided as data inputs in, e.g., a form of synthesized user research data 4 for both data and metadata collections in the knowledge corpus 252 for the primary end users 10. The knowledge corpus 252 may be created by the personal creator/updater 250 using, e.g., machine learning (ML) and natural language processing (NLP). Common patterns and themes may be identified in the knowledge corpus 252, and from these common patterns and themes, a composite persona 230 may be created and/or recommended for all types of end user(s) 10 or user segments 10.1-10.N. In some embodiments, there is a rating system for common patterns and/or themes that surface based on multiple end users' 10 preferences to determine a particular attribute of the persona 230. The primary persona(s) 230.1 and possibly secondary persona(s) 230.2 or more may be determined.

The synthesized user research data 4 may also be collected by metaverse users' 5 previous Metaverse 210 engagements with other metaverse users 5, and avatars 220, etc. The synthesized user research data 4 may be collected by the persona creator/updater 250. This may be done by studying past metaverse user 5 behavior via Metaverse analytics or using any other sources of existing data about the end users 10, such as from publicly available social media platforms and the like and contexts, such as the metaverse environment 215 or contexts of the real-world end users 10. Furthermore, end user 10 information 20 may be manually (e.g., by the persona developer user 3) or automatically collected interactively by conducting interviews with the end users 10, having the end users 10 fill out questionnaires, holding brainstorming sessions, etc. The collected end user information 20 may be structured or non-structured, or in any other form.

The collected end user information 20 may then be processed into a standardized form to produce synthesized user research data 4, and the synthesized user research data 4 may be thus organized and stored in a knowledge corpus 252 of the persona creator/updater 250. This knowledge corpus 252 may comprise information about the personas 254, various environments 256, and various work flows 258 that may be usable in the Metaverse 210. The synthesized user research data 4 may be used as training data to train a persona 230.

According to some embodiments, the persona 230 may be created and based on the various researched inputs (e.g., the synthesized user research data 4) to construct a composite AI interactive persona/archetype in a virtual environment, here, this is the avatar-persona 220, 230 within the Metaverse 210 or a metaverse environment 215. This persona 230 may be accessed in an extended reality (XR) (e.g., the metaverse environment 215) setting, and may be responsive to questions asked by the metaverse users 5 and may provide the metaverse users 5 with insights to activities occurring in the metaverse environment 215 without being prompted. There may be a conversational element to the persona 230, and hence, the persona 230 may have the ability to respond to queries from users and may, in some embodiments, pinpoint insight gaps in an EDT workshop. The conversational element may be implemented as a question-and-answer component 242 of a dialog engine 240.

The persona 230 may engage in real-time learning, and response times may be based on fixed activities, such as EDT workshops. The persona 230 may have an ability to offer insights based on inputs of the metaverse users 5. The persona 230 may also ask questions using its question and answer component 242 of its dialog engine 240. The interactions with metaverse users 5 may allow the persona 230 to evolve over time. This may be accomplished by adding insights and real time synthesis of information based on situational analysis to be fed back into the knowledge corpus 252.

### End User Segmentation 310

The end user segmentation operation 310 may focus on end user 10 definition(s) in the Metaverse 210 or within a particular Metaverse environment 215—in particular, different end user 10.1-10.N classifications may be established for a particular Metaverse environment 215 or various sub-environments thereof. Various types of roles and responsibilities for various end users 10 may be established, each mapping the end user's 10 activities for the roles they are experiencing and facilitating within the Metaverse 210. This is training the model for various types of end users 10, or, rather, there personas 230, to later utilize the various embodiments of metaverse user 5 interface interactions.

For example, a persona developer user 3 may interview the end users 10 of the prospective metaverse users 5, asking questions that may be relevant to a particular field that may represent a particular metaverse environment 215. The end users 10 may represent specific types of people, and these types may be segregated into the end user segments 10.1-10.N or types based on some predefined segregation criteria. The synthesized user research data 4 may be used to build a composite conversational persona 230 that may be utilized as an information resource and provide insights/inputs for metaverse users 5. Different personas 230.1-230.N may be constructed from the end user segments 10.1-10.N, each segment being based on one or more end users 10.

A user segmenter 270 may be used to segment users 10 into user groups/segments 10.1-10.N. The goal of user segmentation is to identify, create, and/or modify a set of personas 230.1-230.N, each of which represents a key or important user group/segment 10.1-10.N. The user segmenter 270 may perform segmentation automatically by using the hierarchy of categorized user input, e.g., by comparing user inputs from the knowledge corpus 252 that may have been provided based on the synthesized user research data 4 from the organizing user information operation 305 and identifying like groups of users 10.1-10.N.

To enable the user segmenter 270 to perform automatic user segmentation in subsequent operations, a schema may be established by the user segmenter 270 that maps the user information 20 to a specific category. A simple example would be defining the category “Age”, and then category mapping the ages of users 10 to that category. More complex answers may be solicited from the users 10 in the form of, e.g., free form text. However, even using such complex answers, the process of category mapping user inputs to categories by the user information collector and organizer 252 may remain the same.

To enable both segmentation and the generation of avatar 220 responses, a user information collector and organizer may map lower-level categories to higher-level categories. For instance, the lower-level categories, “age”, “gender”, and “role” may be mapped to a higher-level category called “demographic”. This mapping may allow the user segmenter 270 to compare end users 10 not on the level of individual features, but rather based on a set of like features. The avatar 220 may then be able to answer questions regarding these higher-level categories (e.g., “what is the demographic of the persona?”). This depth of the mapping is not limited. It may be useful to create a flat hierarchy, or, to provide more fidelity to the downstream algorithms, a multi-level mapping may be established. The output of segment users operation 310 may be a hierarchy of categorized user input, i.e., user input organized into categories, which are mapped into a hierarchy of higher-level categories.

The Metaverse environments 215 and their appertaining/corresponding end user groups or representatives 10.X may be designed in a hierarchical manner, with sub- and sub-sub-environments defining more specific and detailed environments, and sub- and sub-sub-end user categories defining more specific and detailed categories for the end users 10. Any number of levels may be present in such hierarchies. For example, in the Use Case 1, discussed below, a Metaverse environment 215 and the respective end-user category 10.X may be designated as a “training environment for designers”, a sub-environment may be “computer design training for computer designers”, and a sub-sub-environment may be “VR user experience design training for computer VR user experience designers”.

A classifier using, e.g., a cluster algorithm 274, may be used to segment the end users 10. The user segmenter 270 may compare the end user 10 information in the knowledge corpus 252, such as the hierarchy of categorized user input, by using a “distance” determination. For example, a “distance” between information from two user 10 answers may be calculated by a distance calculator in a similar way to a distance calculation performed in traditional clustering approaches, and this distance may be determined for a specific metaverse environment 215. For the distance calculator, some of the distance calculations may be trivial (e.g., distance between the age of users), while other distance calculations may require pre-processing before a distance can be calculated (e.g., for free text). Hence, a specific distance calculation may be established for each of the input categories.

Various distance calculations may be used by the distance calculator. In some instances, a basic distance calculation is made. This calculation may be used for types of inputs that can be compared trivially. This may include any type of numeric input (e.g., age, years of experience, etc.). In this instance, no additional setup is needed to calculate the distance. In some instances, a text distance calculation is made. Here, since free text cannot be compared directly, features are established that will represent the text in the distance comparison. For this, known techniques of natural language processing (NLP) may be used. By way of example, in this scenario, first, the text of all users is tokenized (split up into words) and all tokens are then vectorized. The similarity between two user inputs may then be calculated as the number of tokens that appear in both texts. Other processing may be applied to optimize the distance function, such as stemming or n-gram extraction.

In some instances, a discrete value distance calculation is made. A common type of answers in user research are discrete answers (e.g., tools used in the past or at “pain points”, such as those described in the Use Cases below). These types of answers are a form of text, which can be treated similar to free text. The values themselves (not tokens as above) are vectorized and the similarity between user inputs is the number of overlapping categories.

In some instances, a complex distance calculation is made. While the above categories could be used to calculate the distance between all answer categories, some distance calculations may benefit from taking into account contextual information. For instance, one could compare the field “location” by using text comparison. But a text comparison may ignore the geospatial relationship between cities. For example, a text comparison that looks to an alphabetical relationship instead of a geospatial relationship might inappropriately consider Fresno, California to be close to Frederick, Virginia. Hence, one may develop specialized distance comparisons for such types.

After the distance calculations are made by the distance calculator, users 10 may then be segmented into user segments 10.1-10.N using a clustering algorithm 274. In the clustering algorithm 274, a distance may be calculated between every pair of users 10. The distance between a pair of users 10 may be based on the distances of each of their responses (answers) to questions. The clustering algorithm 274 may use the distances to decide which users 10 are alike and should fall into a same segment 10.1-10.N. Not all factors are equally important—for instance, age may be a less important factor than years of experience.

The clustering algorithm 274 may thus be trained on ground truth data that maps a set of user inputs to segments 10.1-10.N, and their related personas 230.1-230.N. Training the model may adjust a weighting factor that is associated with each of the features. Hence, the feature “age” may receive a lower weight than “years of experience” and, thus, contribute less to the overall distance between two users.

Most clustering algorithms, such as the clustering algorithm 274 here, produce a set of clusters that contain closely related data points and leave data points that are not close to a cluster un-grouped. That means that the clustering algorithm 274 will not necessarily segment all end users 10, but may identify the core segments represented in the data and leave some users un-clustered, which is in the spirit of traditional user segmentation.

### Prepare and Generate Persona 315

In a traditional process, a one-page summary may be prepared that summarizes common themes, pain points, and other aggregate information about users that are mapped to a persona. However, in the method according to various embodiments disclosed herein, such a summary is not prepared directly. Rather, a questions and answer component may be established by which questions that are posed to the persona 230 associated with the avatar 220 can be answered. The basis for these answers may be the responses from end users 10 in a particular user segment 10.1 that have been mapped to a particular persona 230.1. In this operation, the question-and-answer component may prepare direct answers, textual summary answers, and numeric summary answers. This may constitute the train the persona operation 317, and information may be used from the knowledge corpus 252 based on the synthesized user research data 4. The actual persona 230 itself, including initial persona 230 logic and operating parameters may be prepared and generated here, using, in part, the question-and-answer component.

### Prepare and Generate Dialog Engine 320

A component of the avatar 220 and its persona 230 setup is the underlying dialog engine 240 that receives requests from metaverse users 5 and determines an appropriate response. Any known dialog engine 240 may be used for this application. In one embodiment, IBM's Watson Conversations® may be used to build dialogs and control the interaction with the metaverse user 5. In this operation 320, dialogs may be created that specify the types of questions the avatar 220 would be able to respond to, as well as the method used to identify a response. This may also constitute a part of the train the persona 317 operation.

For a particular avatar persona 230.1, two types of interactions may be created: the first type of persona interaction may be a persona introduction in which the avatar 220 introduces itself by providing key information that defines the particular persona 230.1. The second type of persona interaction may be providing question answers in which the avatar 220 may be able to respond to metaverse users' 5 questions about the persona 230.

### Connect Persona to an Avatar 325

In order to bring the avatar 220 into its full functioning role within the Metaverse 210, or, more particularly, to a metaverse environment 215, the avatar 220 must be connected to a persona 230 having a dialog engine 240. The dialog engine 240 contains the question-answer component 242. When there are a plurality of end user segments 10.1-10.N, each with corresponding personas 230.1-230.N, each persona 230.1-230.N may have its own avatar 220.N, although this is not required, and any mapping of avatars 220 to personas 230 may be implemented, as described above. An avatar 220.1 may switch personas 230.1 to 230.2 based on some trigger, such as a Metaverse context change, a change in surrounding metaverse users 5, a time change, a changing in a line of questions being asked, etc. For example, an avatar 220.1 may be a teacher in a particular classroom in a metaverse environment 215 of a virtual university. The avatar 220.1 may possess the persona 230.1 of a chemistry professor for the first hour, and then when the classroom changes to prepare for the second hour, another persona 230.2 of a math professor may be associated with the avatar 220.1.

### Continuously Update the Metaverse Knowledge Corpus for the Avatar 330

A feedback loop may provide for continuous learning of the persona 230 within the metaverse environment 215. Maintaining the back-end knowledge corpus 252 with information gained from metaverse users' 5 interactions with the personas 230 may be beneficial to the success and future usage of the Metaverse 210 within a particular metaverse environment 215. Personal interaction data relating to metaverse user 5 interactions with the interacting avatars 220 and their respective interacting personas 230 may be cataloged and updated within a specific metaverse environment 215 to help retain the knowledge corpus 252 for the specific categorical information.

In an ongoing dynamic persona 230 representation, the persona 230 archetype may be “plugged in” to an ongoing workflow within a metaverse environment 215. The persona 230 may then monitor the workflow and check the workflow against a set of parameters for that particular metaverse environment 215, which may be stored in a workflow section 258 of the knowledge corpus 252. Anomalies and changes to patterns may be called out, e.g., by providing an alarm, logging a message, or providing some other form of notification, that are specific to that unique metaverse environment 215 or ecosystem. The performance, production, and speed of the workflow may be monitored and measured, and information gleaned from this may be used to enrich the knowledge corpus 252. The persona 230 representations may be designed to align with actual metaverse users 5 that are present within that particular metaverse environment 215, even if users are not fully represented (but are normally present within larger population within the metaverse environment 215).

### Applying the Knowledge Corpus to EDT or Other Related Activities in the Metaverse

A persona 230 may be trained to analyze EDT output and provide insights from the lens/perspective of the persona 230. This enables an understanding of how each persona 230 handles situational analysis within Metaverse 210 interaction(s). A persona 230 may analyze and provide supporting dialogue using its question and answer component 242 during specific EDT design thinking activities, such as empathy mapping, AS IS flow, etc. Questions can be asked of the persona 230 while in an EDT session. Some embodiments may identify gaps during playback and feedback within the metaverse environment 215. Such gaps may include positive experiences, negative experiences, and hybrid experiences (various types of collections of macro driven collections of various experiences).

### Use Cases

The following use cases provide illustrative examples of implementing various embodiments of the invention, but the invention nor the embodiments are to be limited in scope based on these example use cases. Reference numbers used in the Use Cases may be applied to specific instances of the generic elements/types they are associated with for ease of understanding.

### Use Case 1—EDT Facilitator: Basic Example Questions

In a first use case, Allie, an EDT facilitator (the persona developer user 3), often struggles with getting EDT workshop attendees (organized into teams-EDT team members (who are the metaverse users 5 in this use case)) to properly evaluate their ideas. These EDT workshop attendees 5 are designers who design VR experiences for end users 10. In this use case, the metaverse environment 215 involves designer of VR experiences training. In the alternative, a more general metaverse environment 215 “designer training” may be employed, with a sub-metaverse environment “VR experiences designer training” component. For example, a metaverse environment 215 and the respective end-user category 10.X may be designated as a “training environment for designers”, a sub-environment may be “computer design training for computer designers”, and a sub-sub-environment may be “VR user experience design training for computer VR user experience designers”.

In particular, the EDT facilitator 3 is concerned with how well the EDT team member 5 ideas they have prioritized meet the actual needs of VR experience customers (who are the end users 10) that the EDT team members 5 will be designing experiences for, free of the EDT team members' 5 personal biases.

Allie 3 has recently moved her EDT workshops to the Metaverse 210 (now a virtual EDT workshop (VEDTW). Now, after attendee EDT team members 5 complete their initial idea prioritization, Allie 3 introduces them to the avatar 220/virtual personas 230 that they will be working with, who mimic the end users 10/customers of the EDT team members 5. The personas 230 may be embedded within, e.g., XR-generated avatars 220 that the EDT team members 5 can interact with. The EDT team members 5 may then engage within their metaverse environment 215 in a conversation with their avatar 220 embodying the virtual persona 230 based on the persona's 230 categorical content.

In this use case, the EDT team members 5 may ask the avatar 220 questions and probe the avatar 220 for insights on categorical content that can help the EDT team members 5 more accurately evaluate and understand how well their ideas meet the real needs of the end users 10 that the EDT team members 5 are designing experiences for. After gaining a better understanding of what is important to their virtual persona 230 serving as a proxy to their ultimate end user 10, the EDT teams members 5 are able to quickly refine and strengthen their ideas. These interactions may take place within a specific Metaverse environment 215.

In this use case, the idea is to create a budget-conscious travel planner that scrapes data of like profiles (e.g., user data collected from a variety of sources) and aggregates the data to answer questions. The avatar 220 answers the questions of the EDT team members 5 revealing desired or preferred features based on the aggregate data. The following questions asked by the EDT team members 5 to the avatar 220 are illustrative examples:
If you were able to create a daily planner based on your total budget for a trip, what would be the most important things to start with (for example, the hotel, dining, entertainment, etc.)?
Do you prefer to have an itinerary made for you, or would you rather build it yourself? [The avatar 220 then answers.] Why is that a better option for you?
What other features would you find helpful in a planner like this?
Of the features you just described which are the most important to you? Why?

Here, data points for the persona 230 may include: demographic information, including work, home, and personal information; pain points, which may be identified during an empathy mapping activity and/or end user 10 interviews (including what the end user 10 sees, hears, does, feels, etc.); goals, which may be identified during a design thinking exercise and/or end user 10 interviews; and a current state process/AS-IS situation, which may be identified during the design thinking activity.

Use Case 2—Designer: Validating and Clarifying being Available for Clarifying Questions

In a second use case, Randy, a designer, as a metaverse user 5, is attending a workshop for a global finance client (end user 10) within the Metaverse 210. He has been assigned to a specific team (metaverse users 5) that normally meets within a particular metaverse environment 215. Part of his team 5 is Bill, an intelligent XR avatar 220, who is representative of a specific persona 230 in the virtual workshop (metaverse environment 215). Bill 220 introduces himself to the team. Bill 220 then tells a story of how difficult it can be to keep up with the fragmentation of various programs and systems he has to go through every day, just to send a file to his “team”.

From this communication by Bill 220, Randy 5 was able to get a firm understanding of Bill's pain points as a lead auditor persona 230. Bill 220 asked Randy 5 if he had any follow up questions. Randy 5 did have a few questions about his current process that Bill 220 was able to specifically answer as they continued to utilize their metaverse environment 215 as a virtual space. This gave Randy 5 a clear understanding of avatar Bill's 220 pain point and aided in the completion of the AS-IS scenario during the EDT Workshop.

Example questions for avatar Bill 220 as a persona 230 who understands the banking audit process, following the scenario above, might include:
1. What applications do you use?
2. How often do you use them?
3. In what order do you use them?
4. Who do you collaborate with typically?

### Use Case 3—Client/Stakeholder

In a third use case, Sarah, a product manager, as a metaverse user 5, oversees the development of a new health application. She is attending a sprint retrospective hosted by her IBM team (also metaverse users 5) in a metaverse environment 215 in the Metaverse 210 and wants to be sure that the work done over the last two weeks is aligned with her potential customer's (end user's 10) needs. As part of the playback, Jennifer and Lucy, the primary personas 230, are brought to life as intelligent XR avatars 220 within the metaverse environment 215. They join the retrospective. Sarah 5 and the IBM team 5 are able to engage the avatars 220 in usability testing of a prototype within their specific Metaverse environment 215, explaining the design decisions made, and gathering feedback on how well the new application meets their needs.

### Use Case 4—Avatar Monitors a Design Thinking Session

In a fourth use case, the avatar 220 may speak up when there are insights or when an activity has ended. Here, Sam, an EDT workshop attendee and his team, as metaverse users 5, have come up with several ideas for a banking application they feel solves the pain points experienced by their end user 10, a college graduate who is just entering the workforce and needing help managing her finances. While the EDT team 5 feels these ideas are great, Sam 5—who is much closer to the age of this end user 10 than his colleagues 5—is not sure any of their ideas really meet the needs of their end user 10, represented by a new college graduate persona 230.

Sam 5 initiates an interaction with the intelligent avatar 220 of their new college graduate persona 230. He explains to the team that they actually have a sponsor end user 10, in the form of the avatar 220, with whom they can validate the ideas with. Sam 5 describes the first idea to the avatar 220 with the new college graduate persona 230. This persona 230 analyzes the first idea against demographic and behavioral data as well as the success of similar applications. Based on this analysis, the persona 230 responds that the majority of people like her would not find this first idea particularly useful. The persona's 230 analysis of the second and third ideas, however, suggest that they seem quite promising, which enables Sam's team 5 to shift focus and develop the second and third ideas more fully.

The persona 230 may be asked additional questions that may help better understand the problem and solutions. For example, the metaverse users 5 might ask any or all of the following questions:
1. Which of the ideas would best solve the pain points identified?
2. What research are you using to support your claim that the first idea would not work well?
3. Can you apply the prioritization grid to the ideas measuring feasibility and impact?

The answers provided by the persona 230 may cause further ideas to be generated or encourage follow-up questions that yield additional information.

### TECHNICAL APPLICATION

The one or more embodiments disclosed herein accordingly provide an improvement to computer technology, namely to an improvement to communications and collaboration within a VR universe, such as the Metaverse 210.

What is claimed is:

1. A method of Metaverse collaboration, comprising:
receiving end user information of end users to produce synthesized user research data;
storing the synthesized user research data in a knowledge corpus;
segmenting the end users into one or more end user segments based on end user roles or end user categories;
generating, for each end user segment, a persona, each representing a composite of end users in a respective end user segment;
training each persona with training data from the synthesized user research data of the end users in the respective end user segment;
generating a dialog engine for each persona based on the training;
connecting an avatar to each persona; and
making each avatar accessible for dialog with metaverse users in the Metaverse, wherein the Metaverse is a 3D virtual reality environment.

2. The method of claim 1, further comprising:
receiving persona interaction data based on an interacting persona that interacts with a metaverse user;
adding the persona interaction data to the training data in the knowledge corpus; and
subsequently training an other persona using the persona interaction data in the training data of the knowledge corpus.

3. The method of claim 1, wherein the knowledge corpus comprises persona data, environment data, and workflow data.

4. The method of claim 1:
wherein the end user information comprises end user answers from end users in response to end user questions;
the method further comprising:
adding end user questions and end user responses to the synthesized user research data in the knowledge corpus; and
creating a question and answer component as a part of the dialog engine that is usable by an interacting persona.

5. The method of claim 1, wherein the end user information comprises publicly available existing data about the end users or their contexts.

6. The method of claim 1, wherein:
each avatar is accessible within a metaverse environment;
the metaverse environment is a virtual enterprise design thinking workshop (VEDTW);
the metaverse users are VEDTW students; and
the dialog engine is structured around the VEDTW.

7. The method of claim 6, further comprising applying generated insights during situational analysis while EDT activities are in progress.

8. The method of claim 1, wherein the dialog engine facilitates questions, comments, conversations, and random injections.

9. The method of claim 1, wherein the producing of the synthesized user research data comprises:
using machine learning and natural language processing to update the knowledge corpus;
identifying common patterns and themes; and
using the common patterns and themes in the generating of the persona.

10. The method of claim 9, further comprising using a rating system for the common patterns and themes to determine a particular attribute of the persona.

11. The method of claim 1, wherein the segmenting of the end users comprises using a classifier that is a cluster algorithm that uses a distance calculator.

12. The method of claim 1, further comprising:
plugging in the persona to an ongoing workflow;
checking the workflow against a set of workflow parameters stored in a workflow data portion of the knowledge corpus; and
calling out identified anomalies and changes to workflow patterns.

13. A Metaverse collaboration apparatus, comprising:
a memory; and
a processor that is configured to:
receive end user information of end users to produce synthesized user research data;
store the synthesized user research data in a knowledge corpus;
segment the end users into one or more end user segments based on end user roles or end user categories;
generate, for each end user segment, a persona, each representing a composite of end users in a respective end user segment;
train each persona with training data from the synthesized user research data of the end users in the respective end user segment;
generate a dialog engine for each persona based on the training;
connect an avatar to each persona; and
make each avatar accessible for dialog with metaverse users in the Metaverse, wherein the Metaverse is a 3D virtual reality environment.

14. The apparatus of claim 13, wherein the processor is further configured to:
receive persona interaction data based on an interacting persona that interacts with a metaverse user;
add the persona interaction data to the training data in the knowledge corpus;
subsequently train an other persona using the persona interaction data in the training data of the knowledge corpus;
wherein the end user information comprises end user answers from end users in response to end user questions;
the processor further being configured to:
add end user questions and end user responses to the synthesized user research data in the knowledge corpus; and
create a question and answer component as a part of the dialog engine that is usable by an interacting persona.

15. The apparatus of claim 13, wherein:
each avatar is accessible within a metaverse environment;
the metaverse environment is a virtual enterprise design thinking workshop (VEDTW);
the metaverse users are VEDTW students; and
the dialog engine is structured around the VEDTW;
the processor is further configured to:
apply generated insights during situational analysis while EDT activities are in progress.

16. The apparatus of claim 13, wherein:
the production of the synthesized user research data comprises causing the processor to:
use machine learning and natural language processing to update the knowledge corpus;
identify common patterns and themes; and
use the common patterns and themes in the generating of the persona;
the processor is further configured to:
use a rating system for the common patterns and themes to determine a particular attribute of the persona.

17. The apparatus of claim 13, wherein the segmentation of the end users comprises causes the processor to use a classifier that is a cluster algorithm that uses a distance calculator.

18. The apparatus of claim 13, wherein the processor is further configured to:
plug in the persona to an ongoing workflow;
check the workflow against a set of workflow parameters stored in a workflow data portion of the knowledge corpus; and
call out identified anomalies and changes to workflow patterns.

19. A computer program product for a Metaverse collaboration apparatus, the computer program product comprising:
one or more computer readable storage media, and program instructions collectively stored on the one or more computer readable storage media, the program instructions comprising program instructions to:
receive end user information of end users to produce synthesized user research data;
store the synthesized user research data in a knowledge corpus;
segment the end users into one or more end user segments based on end user roles or end user categories;
generate, for each end user segment, a persona, each representing a composite of end users in a respective end user segment;
train each persona with training data from the synthesized user research data of the end users in the respective end user segment;
generate a dialog engine for each persona based on the training;
connect an avatar to each persona;
make each avatar accessible for dialog with metaverse users in the Metaverse, wherein the Metaverse is a 3D virtual reality environment;
receive persona interaction data based on an interacting persona that interacts with a metaverse user;
add the persona interaction data to the training data in the knowledge corpus;
subsequently train an other persona using the persona interaction data in the training data of the knowledge corpus;
add end user questions and end user responses to the synthesized user research data in the knowledge corpus;
create a question and answer component as a part of the dialog engine that is usable by an interacting persona; and
apply generated insights during situational analysis while EDT activities are in progress;
wherein:
the knowledge corpus comprises persona data, environment data, and workflow data; and
the end user information comprises end user answers from end users in response to end user questions;
each avatar is accessible within a metaverse environment;
the metaverse environment is a virtual enterprise design thinking workshop (VEDTW);
the metaverse users are VEDTW students;
the dialog engine is structured around the VEDTW;
the dialog engine facilitates questions, comments, conversations, and random injections; and
the producing of the synthesized user research data comprises:
using machine learning and natural language processing to update the knowledge corpus;
identifying common patterns and themes; and
using the common patterns and themes in the generating of the persona.

20. The computer program product of claim 19, wherein the program instructions further configure the processor to:
apply generated insights during situational analysis while EDT activities are in progress;
use a rating system for the common patterns and themes to determine a particular attribute of the persona;
plug in the persona to an ongoing workflow;
check the workflow against a set of workflow parameters stored in a workflow data portion of the knowledge corpus; and
call out identified anomalies and changes to workflow patterns;
wherein:
the end user information comprises publicly available existing data about the end users or their contexts; and
the segmenting of the end users comprises using a classifier that is a cluster algorithm that uses a distance calculator.
